(19) United States
(12) Patent Application Publication
(10) Pub. No.: US 2014/0156452 A1
(43) Pub. Date: Jun. 5, 2014

(54) SYSTEM AND METHODS TO FULFILL AN AGGREGATED ONLINE ODRER FOR RELATED USERS

(71) Applicant: Roi Lupo, Raanana (IL)

(72) Inventor: Roi Lupo, Raanana (IL)

(73) Assignee: eBay Inc., San Jose, CA (US)

(21) Appl. No.: 13/706,197

(22) Filed: Dec. 5, 2012

(51) Int. Cl. G06Q 30/06

(52) U.S. Cl. CPC G06Q 30/0633
USPC 705/26.8

(57) ABSTRACT

A method and a system to aggregate items purchased by various users into one online order are provided. A first payment for an online order is received from a first user, the online order indicating an item purchased by the first user from an online merchant. A message to one or more other users is sent, the message indicating that the first user has initiated the online order from the online merchant and including an option to add a purchase to the online order. A second payment and an indication of an item purchased by a second user from the online merchant are received from the second user. The item purchased by the second user is aggregated to the online order. The online order including the item purchased by the first user and the item purchased by the second user is fulfilled.

### TECHNICAL FIELD

The present application relates generally to the technical field of data processing and, in one specific example, to fulfill an aggregated online order in a network commerce system.

### BACKGROUND

An order may be placed by a user with an online merchant over a network commerce system. The user may also send a payment to the online merchant to pay for the items included in the order. Upon receiving the payment, the online merchant may package and deliver the items ordered by the user.

### BRIEF DESCRIPTION OF THE DRAWINGS

Some embodiments are illustrated by way of example and not limitation in the figures of the accompanying drawings in which:

FIG. 1 is an example network diagram of an environment where various embodiments may be implemented.

FIG. 2 is a block diagram of an item and payment aggregation system, according to some embodiments.

FIG. 3 is a flowchart of a method to aggregate an item to an online order and then fulfill the aggregated order, according to some embodiments

FIG. 4 is a portion of a user interface depicting an option to share an online order, according to some embodiments.

FIG. 5 is a portion of a user interface depicting that a message has been sent to other users, according to some embodiments.

FIG. 6 is a portion of a user interface depicting the message that was sent to the other users including an option to add a purchase to the online order, according to some embodiments.

FIG. 7 is a portion of a user interface depicting a purchasing of items from a merchant, according to some embodiments.

FIG. 8 is a portion of a user interface depicting a list of users that have aggregated items to the online order, according to some embodiments.

FIG. 9 is a portion of a user interface depicting a list of the items that have been delivered in the online order, according to some embodiments.

FIG. 10 illustrates an example diagram of a representation of a machine in the example form of a computer system that may be used, according to some embodiments.

### DETAILED DESCRIPTION

Example methods and systems to aggregate items purchased by various users into one online order are described. In the following description, for purposes of explanation, numerous specific details are set forth in order to provide a thorough understanding of example embodiments. It will be evident, however, to one skilled in the art that the present invention may be practiced without these specific details.

When a user purchases an item from an online merchant, an online order is initiated. The user may opt to share the online order with a number of people. When the user shares the online order, a system sends a message to selected people inviting them to add items to the online order. After receiving the message, a second user is allowed to add an item to the order and separately pay the merchant for the item. Once the online order is complete, the merchant fulfills the online order by shipping all of the items—regardless of buyer—to one geographic location. The users who added items to the order may save on shipping costs because delivery is only to a single destination, rather than multiple destinations. Specifically, one user may pay the entire shipping cost or the shipping cost may be divided amongst the buyers participating in the online order.

In some embodiments, the order is considered complete after a period of time has elapsed. For example, the online order may be held open for a period of two days before it is considered complete. In some embodiments, the order is considered complete once a minimum number of items are added to the aggregated online order. In some embodiments, the order is considered complete after a minimum number of users have added items to the aggregated online order.

In some embodiments, a payment submitted with the online order by a first user may be a final payment. A final payment may be the full purchase price and shipping costs of all of the items included in the online order by the first user. Upon fulfillment of the order, at least a portion of the shipping costs included in the final payment may be refunded to the first user. In some embodiments, the payment submitted with the online order by the first user may be a non-final payment in which funds are not actually transferred until fulfillment of the online order. In this scenario, the non-final payment will be finalized and transferred after a final payment amount is calculated.

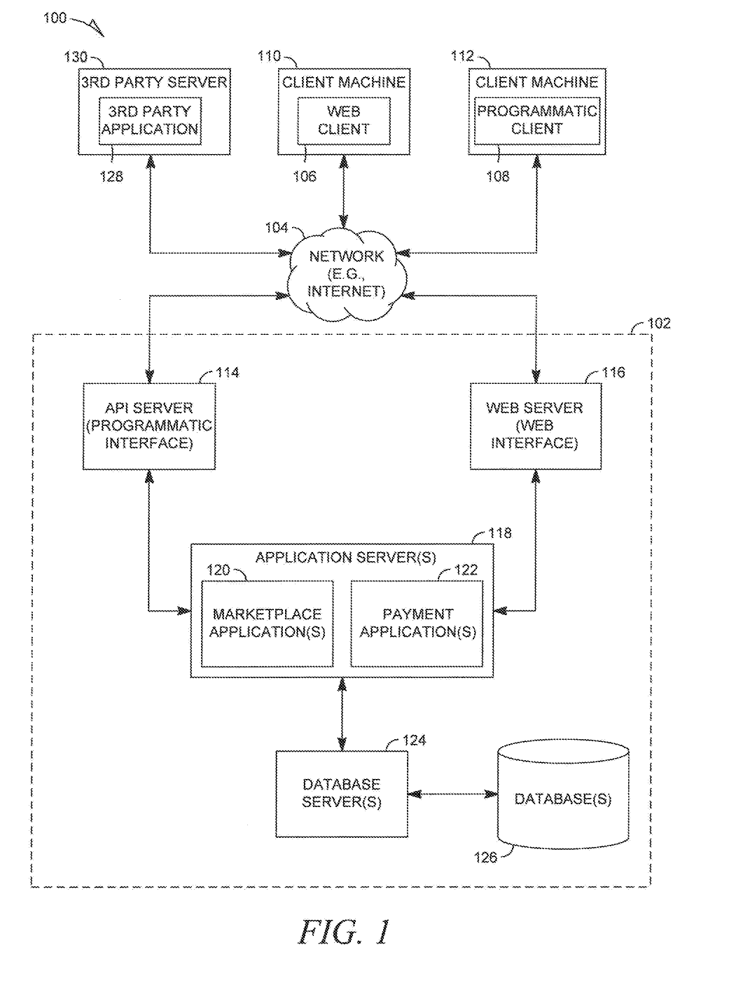

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, he a seller application (e.g., the TurboLister application developed by eBay Inc,, of San Jose, Calif.) to enable sellers to author and manage listings on the networked system 102 in an offline manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

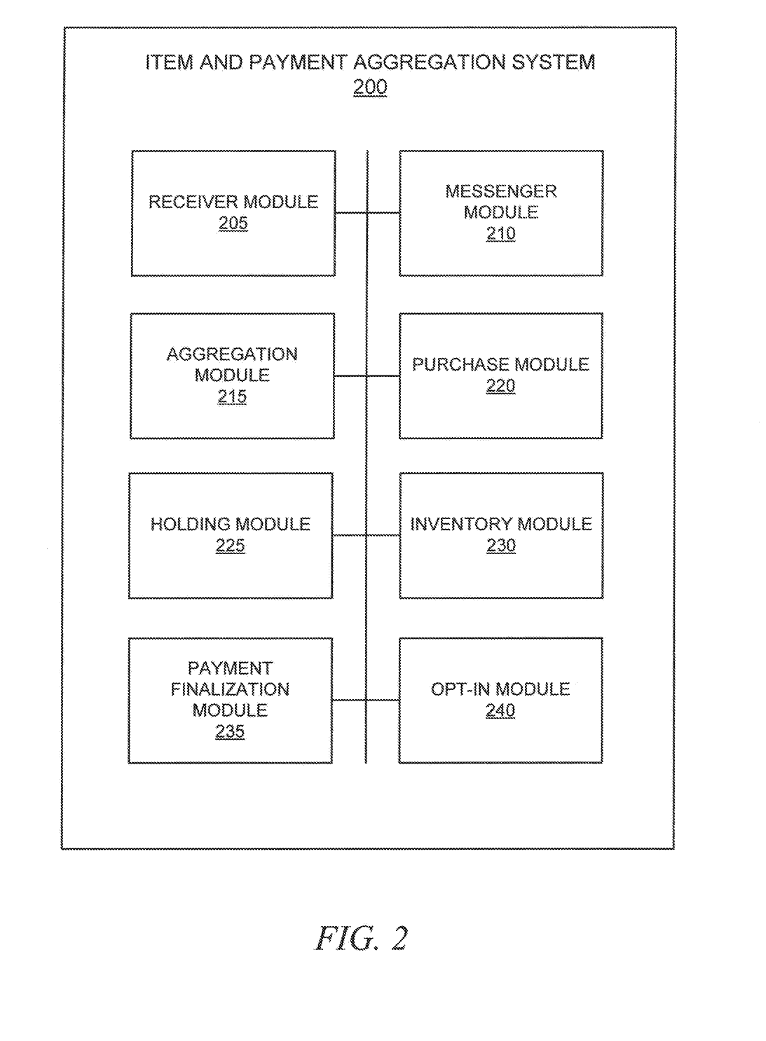

FIG. 2 is a block diagram of an item and payment aggregation system 200, according to some embodiments. The system 200 may be implemented as hardware or as software executed by hardware (e.g., by one or more processors) comprises a receiver module 205, a messenger module 210, an aggregation module 215, a purchase module 220, a holding module 225, an inventory module 230, a payment finalization module 235, and an opt-in module 240.

In some embodiments, the receiver module 205 is configured to initiate an online order with a first user. As part of the initiation of the online order, the receiver module may receive a selection indicating one or more items being purchased by the first user and first payment information or a first payment from the first user. The first user may place the online order through a third party server in the form of an email, a text message, a merchant application, and the like. The receiver module 205 then receives the online order from the third party server. The online order may include a description of at least one item that the first user is purchasing from the online merchant.

In some instances, the online order may be a preliminary order that will only be finalized on receiving a final approval from the first user. The first user may grant a final approval once the first user considers the order to be complete. In some embodiments, the order is considered complete after a period of time has elapsed. For example, the online order may be held open for a period of two days before it is considered complete. In some embodiments, the order is considered complete once a minimum number of items are added to the aggregated online order. In some embodiments, the order is considered complete after a minimum number of users have added items to the aggregated online order. In the event the first user does not grant final approval to the preliminary order, the online order will not be fulfilled by the online merchant and will be cancelled. As a result of the cancelled order, the first user may be refunded any payments sent to the receiver module 205.

After initiating the online order, the first user may identify other users who may participate in the online order. The item and payment aggregation system 200 may present the first user with a list of other users. The list may comprise of individual users and groups of users. The individual users may be, for example, friends and family of the first user. The groups of users (or individual users) may be (or belong to) social groups with whom the first user associates. Alternatively, the item and payment aggregation system 200 may communicate with a third party server to present a list to the first user. For example, after placing a preliminary order, the first user may be redirected to an email system with which the first user has an email account. From the email system, the first user may select email contacts with whom to share the online order. Alternatively, the first user may be redirected to a social network for which the first user has a user account. From the social network, the first user will select “friends” to share in the online order. Once the first user has finished selecting, the third party server may communicate the first user's selection to the item and payment aggregation system 200. In some embodiments, the first user's selection may be tracked and recorded by the item and payment aggregation system 200.

After the first user makes a selection, the messenger module 210 may send a message about the online order to the other users selected by the first user. The message may be sent through a third party server over a network to each of the selected users. For example, the email system may send the message over the network to an email account owned by each user of the selected users. As another example, the social network may send the message to a social network account owned by each user of the selected users.

As the first user is selecting other users to share the order with, the holding module 225 delay's the online merchant from fulfilling the online order. The holding module 225 may instruct the merchant to delay fulfilment of the online order until the order is considered complete.

Upon receiving instructions to delay fulfilment from the holding module 225, the online merchant may place the items described in the online order on hold until further notice. Any subsequent purchasers not included in the online order will not be able to purchase the items placed on hold. In some embodiments, the online merchant will keep the items on hold until the order is considered complete. Upon completion of the order, the merchant will deliver the items placed on hold to a single geographic location. In some embodiments, if the online order is cancelled, the items will no longer be on hold. Instead, the items will be returned to the merchant's inventory as items available for sale.

The message sent from the first user may indicate that the first user has initiated the online order from the online merchant. The message includes an option for the other users to also purchase items from the online merchant. The option may include a link to redirect the users to the merchant's website hosted on a third party server. After the other users make a selection from the merchant's website, a description of the items selected may be sent to the aggregation module 215. Alternatively, the message itself displays descriptions of the merchant's inventory in order to allow the other users to select and choose items to purchase from the online merchant. Once selection is complete, the description of the items chosen by the users may be sent to the aggregation module 215.

The aggregation module 215 is configured to receive from a second user of the other users a description of at least one item that the second user is purchasing from the online merchant. In some embodiments, the description submitted by the second user may result from the message sent to the second user regarding the first user's online order. In some embodiments, the second user is purchasing at least one item that is of the same type that the first user is purchasing. For example, if the first user is purchasing a pair of gloves, the second user may also purchase a pair of gloves o the same type, bringing the order to two pairs of gloves of the same type. Alternatively, the types of items the second user is purchasing are entirely different from the types of items the first user is purchasing. The aggregation module 215 may also receive second payment information or a second payment from the second user for the items that the second user has added to the online order.

In some embodiments, the aggregation module 215 is further configured to include the items the second user is purchasing into the online order. The aggregation module 215 may collect the descriptions of the items purchased by the second user and the descriptions of the items purchased by the first user. Moreover, the aggregation module 215 may also collect the payments from each user for the online order and then combine them into a single payment. As a result, the aggregated online order may include the collected descriptions as well as the combined payment. In some embodiments, the aggregated online order is not limited to items purchased by the first user and the second user. Additional users may purchase items and add them to the aggregated online order as long as the order is still being held open by the holding module 225. In some embodiments, as soon as the order is considered complete, the period of adding items to the online order is closed and the order is ready to be fulfilled.

In some embodiments, the purchase module 220 is configured to fulfill the aggregated online order. The purchase module 220 may send the combined payment and the collected descriptions to the online merchant. The combined payment may be accompanied with instructions for the online merchant to deliver the items purchased by each of the users to an address. The instructions may indicate a single geographic destination for delivery of the items, such as the address of the first user, the address of the second user, and the like.

In some embodiments, the inventory module 230 is configured to update an inventory of the online merchant after the second user has purchased an item from the online merchant. After the aggregation module 215 has received the second payment from the second user, the inventory module 230 may update the merchant's inventory of the item the second user is purchasing. For example, if there are no boots in the merchant's inventory and the second user submits a payment for the boots, then the inventory module 230 will add a new pair of boots. This guarantees the boots to be delivered by the merchant to the second user via the first user.

In some embodiments, the payment finalization module 235 is configured to modify the amount of the first payment and the amount of the second payment based on the aggregation of the online order. The payment finalization module 235 may modify the payments either before the user has finalized the payment or after the user has finalized the payment. The first payment, and successive payments made by other users, may be charged to the appropriate user in various ways. In one embodiment, the payment may be a final payment in which funds are transferred from the user's account to the merchant. To initiate a payment, the user making the payment provides payment information. The payment information identifies an account of the user such as a bank account, a credit card account, a debit card account, a Bill Me Later® account, and the like. Using the payment information, the online merchant may charge the identified account for an amount equal to the payment owed by the first user, thus finalizing the payment.

In another embodiment, a non-final payment is charged to the account by the merchant sending a pre-authorization request indicating an anticipated charge to the account. The anticipated charge may be based on the price of the items purchased by the user making the payment, sales taxes (or Value Added Taxes) owed on those items, and at least a portion of an expected shipping cost.

Upon a finalization of the order, the payment finalization module 235 or the online merchant or another entity may calculate a final amount due. The calculation of the final amount may result in an actual shipping cost that is lower than the expected shipping cost. The actual shipping cost may be lower than the expected shipping cost because more users purchasing items are included in the online order. Once the final amount due is calculated, the final amount is communicated to the payment finalization module 235 to modify the amount of the payments made by the first and the second user.

In the event that the shipping costs are reduced and the user has finalized the payment, the payment finalization module 235 may refund a portion of the first payment made by the first user. The payment finalization module may make a deposit the amount refunded to an account owned by the first user based on the payment information received.

Alternatively, if the first user made a non-final payment, the payment finalization module 235 will charge the first user's account based on the modified payment amount. In one embodiment, the payment finalization module 235 will charge the first user's account according to the actual shipping costs rather than the expected shipping costs. The methods mentioned above may also be applied to the second payment made by the second user as well as any subsequent users that make payments.

In some embodiments, the shipping costs may be divided among the users included in the aggregated online order. The shipping costs may be divided equally among the users. Alternatively, the shipping costs may be divided according to a weight assigned to each user among the users. The weight assigned to each user may be based on a several factors, either singly or in combination, including the destination to where the delivery is being shipped, the geographical distance between the source of the delivery to each of the user's addresses, the payment amount for the items ordered by each user, the weight of the items added to the order by the respective users, and other factors that will be apparent to those skilled in the art.

In some embodiments, the opt-in module 240 is configured to provide the online merchant with the option of opting in to receiving instructions relating to the online order. The instructions include instructions to delay fulfilment of the online order and instructions for delivery of the items to a single geographic destination. In some embodiments, the opt-in module 240 is further configured to have the online merchant allow updates to its inventory by the inventory module 230.

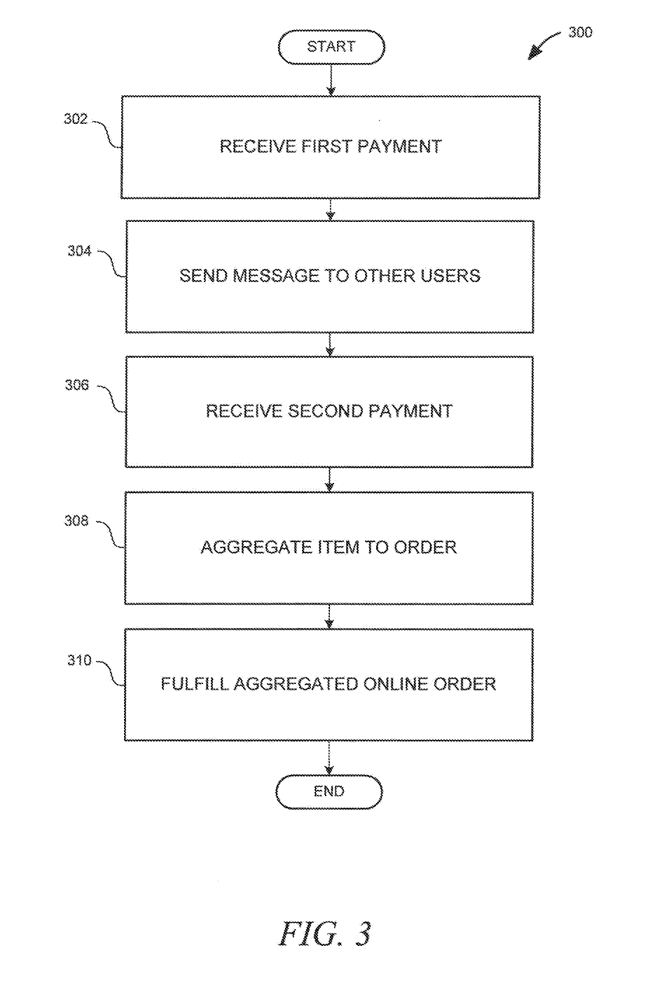

FIG. 3 is a flowchart of a method 300 to aggregate an item to an online order and then fulfill the aggregated order, according to some embodiments. The method 300 begins at step 302 when the receiver module 205 receives a first payment for an online order from a first user. In some embodiments, the online order may indicate an item purchased by the first user from an online merchant. At step 304, the messenger module 210 may send a message to one or more other users regarding the online order. In some embodiments, the message may indicate that the first user has initiated the online order from the online merchant may include an option to add a purchase to the online order. At step 306, the aggregation module 215 may receive a second payment from a second user. In some embodiments, the second payment is accompanied by an indication of an item purchased by the second user from the online merchant. At step 308, the aggregation module 215 may aggregate the item purchased by the second user to the online order. In some embodiments, the aggregation involves including the indication of the item purchased by the second user in the online order. At step 310, the purchase module 220 may fulfill the online order which includes the items purchased by the first and the second user. In some embodiments, fulfillment of the online order involves sending the combined payment to the online merchant and instructing the online merchant to deliver the items to a single destination. The destination specified by the purchase module 220 may be the address of the first user, the address of the second user, and the like.

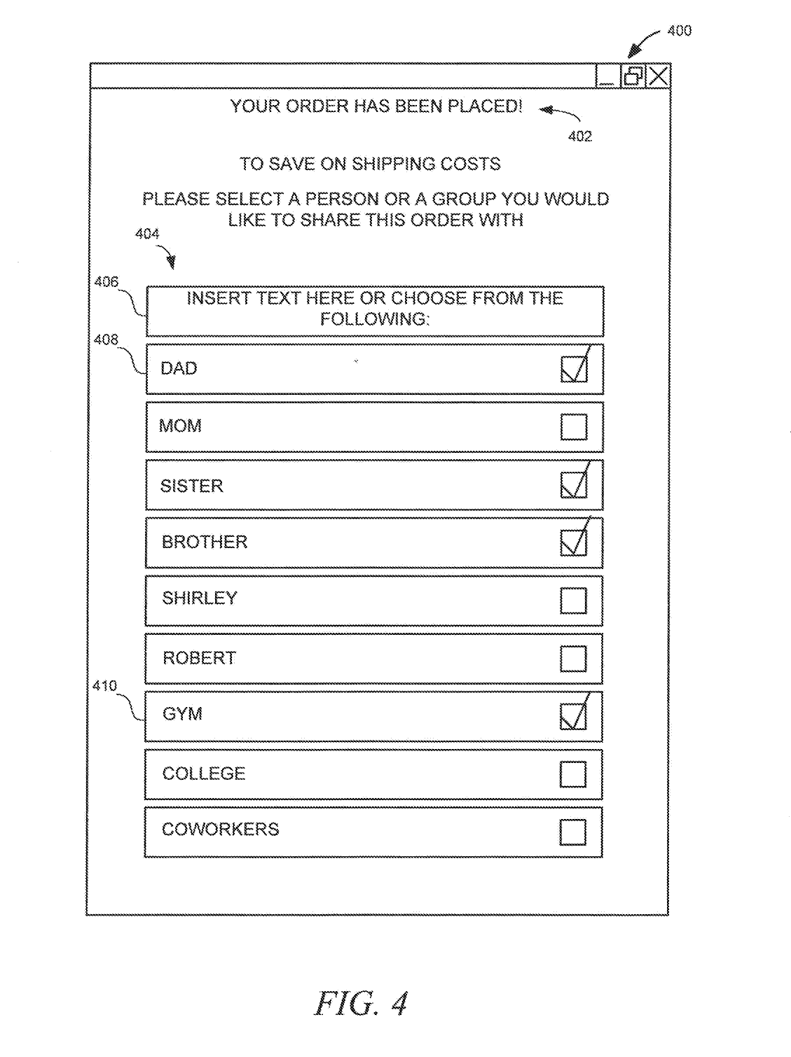

FIG. 4 is a portion of a user interface 400 depicting an option to share an online order, according to some embodiments. After initiating the online order, as indicated by the confirmation message 402, the first user may share the online order with other users. In the user interface 400, the first user may select other users from a list of users 404 comprising of individual users and groups of users. Each entry from the list of users 404 corresponds to an individual user or a group of users and includes a selection box. An entry front the list of users 404 with a checked box indicates that a message may be sent to the corresponding individual user or group of users. Alternatively, an entry from the list of users 404 without a checked box indicates that a message may not be sent to the corresponding individual user or group of users. For example, the list of users 404 includes an entry corresponding to the first user's father 408 with a checked box, indicating that a message may be sent to the first user's father. The list of users 404 also includes entries with labels. The labels may indicate one or more people whom the first user has a relationship. For example, entry 410 is labeled as gym. The gym label may indicate users associated with the gym and whom the first user has a relationship. The user interface 400 also includes a text input box 404 where the first user may type in any information identifying a user to who may participate in the online order. For example, first user may type in a birth name, an identification number (e.g., a telephone number), a screen name for another user within a social network, an email address, an account number, and the like.

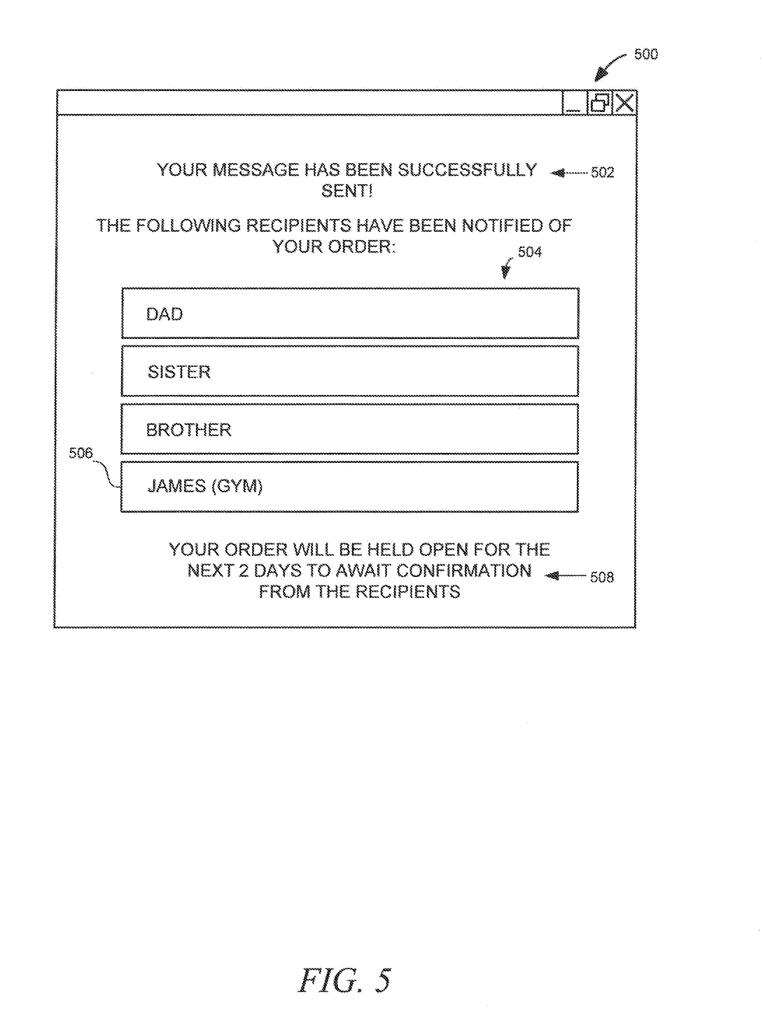

FIG. 5 is a portion of a user interface 500 depicting that a message has been sent to other users, according to some embodiments. In some embodiments, the user interface 500 includes a confirmation message 502 indicates that the message regarding the online order has successfully been sent. In some embodiments, the user interface 500 may be provided after the first user identifies other users to participate in the online order, as depicted in user interface 400 of FIG. 4. A list of users 504 indicates the individuals to whom the message has been successfully sent. For example, entry 506 of the list of users 504 indicates that James has received the message and that James is associated with the gym. In some embodiments, the gym is the same gym that was labeled in entry 410 of the list of users 400 of FIG. 4. The user interface 500 also includes a notification message 508 describing how long the order may be held open before the order is cancelled or fulfilled.

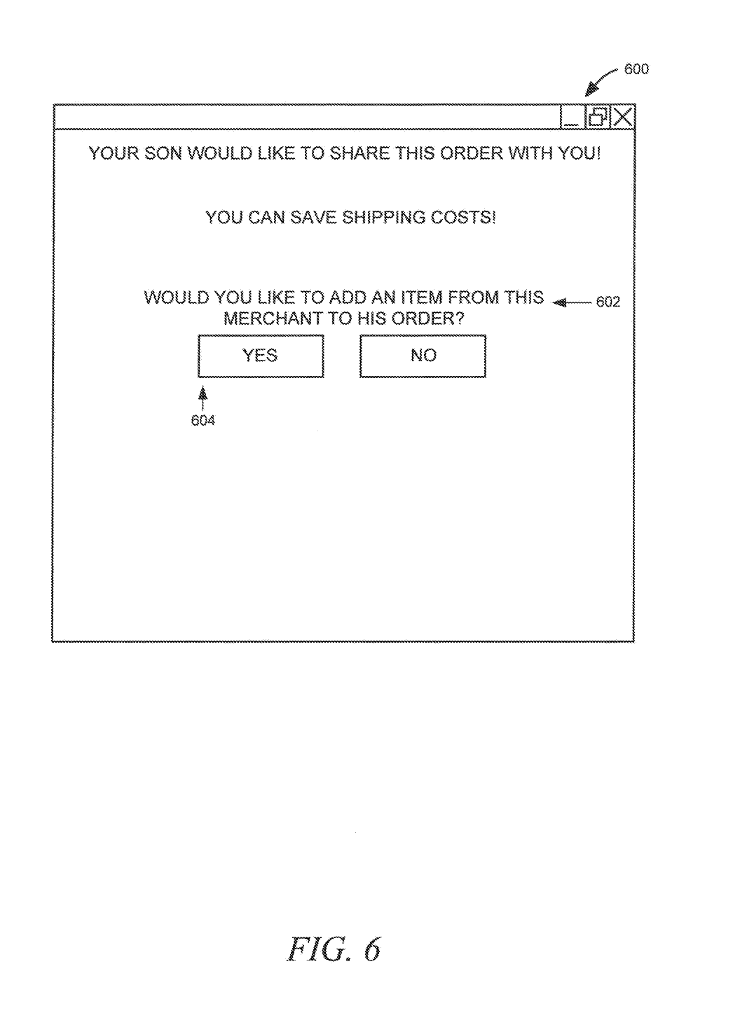

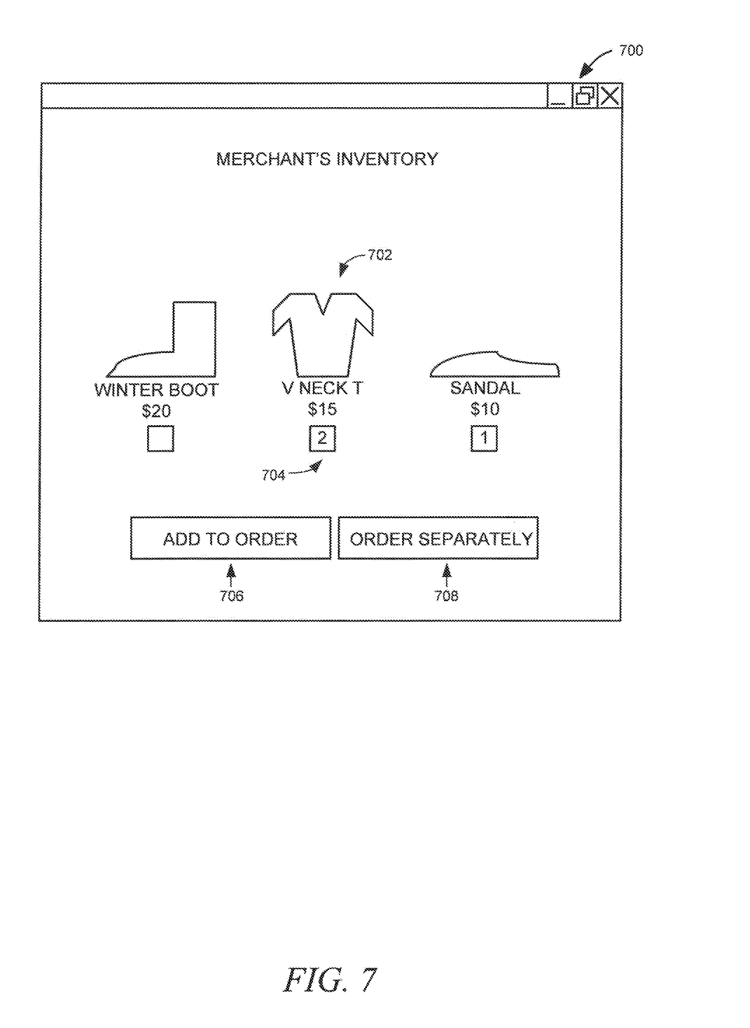

FIG. 6 is a portion of a user interface 600 depicting the message that was sent to the other users including an option 602 to add a purchase to the online order, according to some embodiments. In some embodiments, if the user decides to add a purchase to the online order by clicking on box 604, then the user may be redirected to the user interface depicted in FIG. 7.

FIG. 7 is a portion of a user interface 700 depicting a purchasing of items from a merchant, according to some embodiments. The user interface 700 includes images of products available for sale from the online merchant's inventory. Below each image is a text input box where a user can input a number indicating how many items of each product the user would like to purchase. For example, image 702 depicts a V-neck T-shirt that is available for purchase. The text input box 704 indicates that the user would like to purchase 2 items of the V-neck T-shirt from the online merchant. After making a selection of items to purchase, the user may either add the selected items to the online order by clicking on box 706 or order the items separately from the shared online order by clicking on box 708.

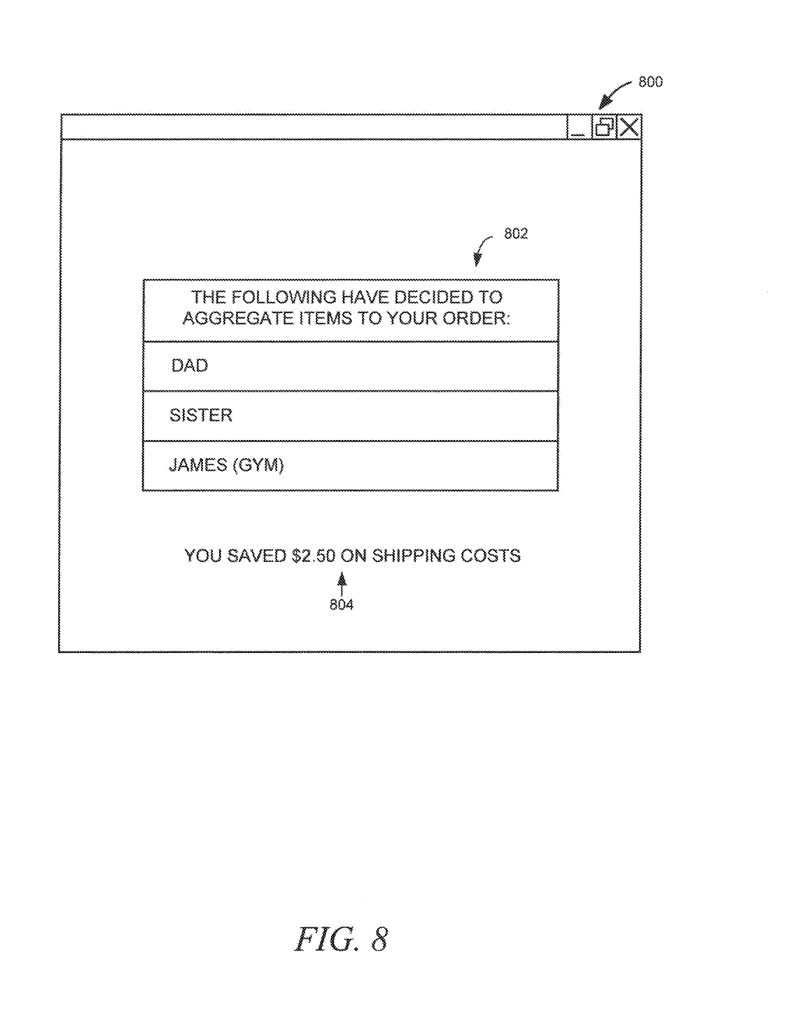

FIG. 8 is a portion of a user interface 800 depicting a list of users 802 that have aggregated items to the online order, according to some embodiments. In some embodiments, there is also a message 804 indicating the amount of money saved. The user interface 800 may be displayed to the first user who shared the online order.

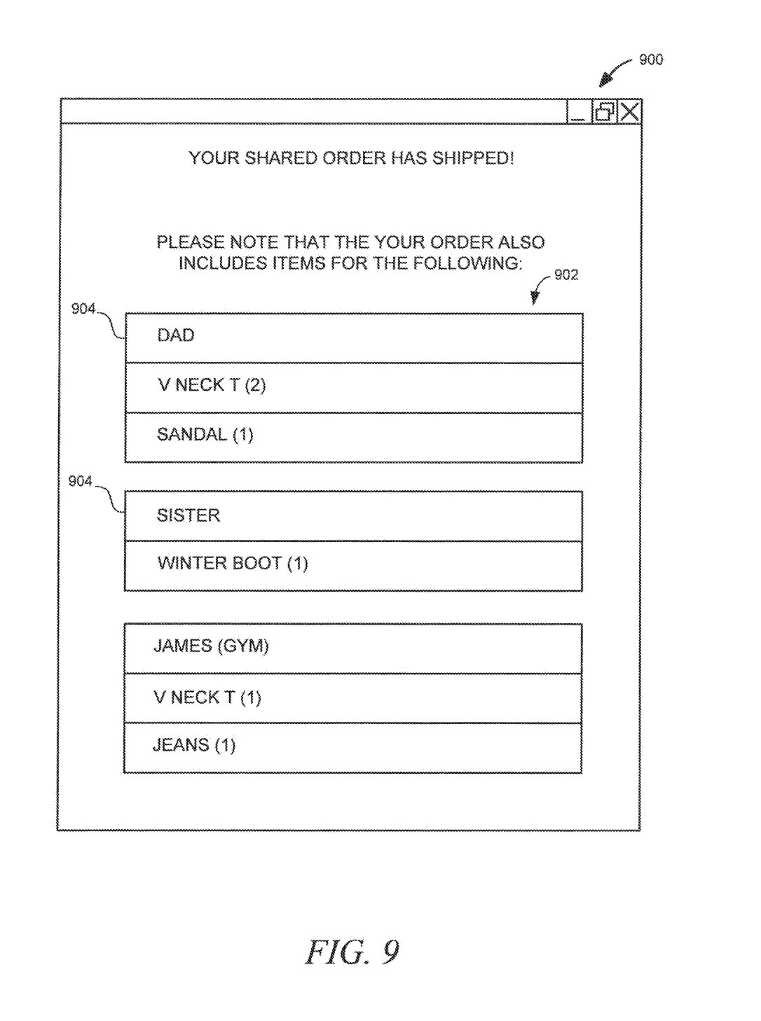

FIG. 9 is a portion of a user interface 900 depicting a list of the items 902 that have been delivered in the online order, according to some embodiments. The list of items 902 may include the user who purchased the items as well as the quantity of items sold for each product. For example, the first entry 904 in the list of items 902 indicates that the first user's dad purchased two V-Neck T-Shirts as well as one sandal from the online merchant. As another example, the second entry 906 in the list of items 902 indicates that the first user's sister purchased one winter boot from the online merchant.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC). in temporarily configured hardware (e.g.,, a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

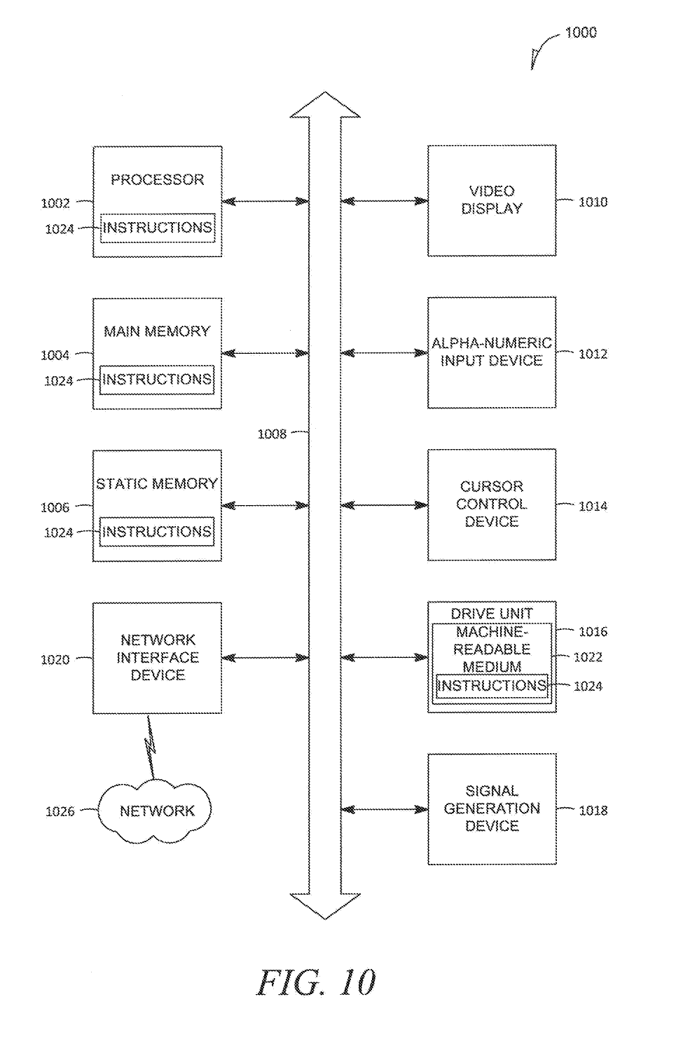

FIG. 10 illustrates an example diagram of a representation of a machine in the example form of a computer system 1000 that may be used, according to some embodiments. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set tor multiple sets) of instructions to perform any one or more of the methodologies discussed herein.

The example computer system 1000 includes a processor 1002 (e.g., a central processing unit (CPU), to graphics processing unit (CPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard or a touch sensitive display screen), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a receiver module configured to receive a first payment for an online order from a first user, the online order indicating an item purchased by the first user from an online merchant;
a messenger module configured to send a message to one or more other users, the message indicating that the first user has initiated the online order from the online merchant and including an option to add a purchase to the online order;
an aggregation module configured to, using one or more processors, receive, from a second user of the one or more other users, a second payment and an indication of an item purchased by the second user from the online merchant and to aggregate the item purchased by the second user to the online order; and
a purchase module configured to fulfill the online order including the item purchased by the first user and the item purchased by the second user.

2. The system of claim 1, wherein the purchase module is further configured to fulfill the online order by sending a combined payment to the online merchant and instruct the online merchant to deliver the item purchased by the first user and the item purchased by the second user to an address of the first user.

3. The system of claim 1, wherein the purchase module is further configured to fulfill the online order by sending a combined payment to the online merchant and instruct the online merchant to deliver the item purchased by the first user and the item purchased by the second user to an address of the second user.

4. The system of claim 1, further comprising:
a holding module configured to instruct the online merchant to delay fulfillment of the online order for a predetermined period of time.

5. The system of claim 4, wherein the holding module is further configured to instruct the online merchant to detect if a condition for fulfillment of the online order has been met before fulfilling the online order.

6. The system of claim 5, wherein the condition for fulfillment of the online order includes a predetermined number of items aggregated to the online order.

7. The system of claim 5, wherein the condition for fulfillment of the online order includes a predetermined number of users purchasing items aggregated to the online order.

8. The system of claim 1, further comprising:
an inventory module configured to update an inventory of the online merchant based on the second payment.

9. The system of claim 1, further comprising:
a payment finalization module configured to modify the amount of the first payment and the amount of the second payment based on the aggregation of the online order.

10. The system of claim 1, further comprising:
an opt-in module configured to provide the online merchant with the option of opting in to receiving instructions relating to the online order and to allow updates to the inventory of the online merchant.

11. A method comprising:
receiving a first payment for an online order from a first user, the online order indicating an item purchased by the first user from an online merchant;
sending a message to one or more other users, the message indicating that the first user has initiated the online order from the online merchant and including an option to add a purchase to the online order;
receiving, from a second user of the one or more other users, a second payment and an indication of an item purchased by the second user from the online merchant;
aggregating, using one or more processors, the item purchased by the second user to the online order; and
fulfilling the online order including the item purchased by the first user and the item purchased by the second user.

12. The method of claim 11, wherein fulfilling the online order includes sending a combined payment to the online merchant and instructing the online merchant to deliver the item purchased by the first user and the item purchased by the second user to an address of the first user.

13. The method of claim 11, wherein fulfilling the online order includes sending a combined payment to the online merchant and instructing the online merchant to deliver the item purchased by the first user and the item purchased by the second user to an address of the second user.

14. The method of claim 11, further comprising:
instructing the online merchant to delay fulfillment of the online order for a predetermined period of time.

15. The method of claim 14, further comprising instructing the online merchant to detect if a condition for fulfillment of the online order has been met before fulfilling the online order.

16. The method of claim 15, wherein the condition for fulfillment of the online order includes a predetermined number of items aggregated to the online order.

17. The method of claim 15, wherein the condition for fulfillment of the online order includes a predetermined number of users purchasing items aggregated to the online order.

18. The method of claim 11, further comprising:
updating an inventory of the online merchant based on the second payment.

19. The method of claim 11, further comprising:
modifying the amount of the first payment and the amount of the second payment based on the aggregation of the online order.

20. A non-transitory machine-readable medium storing instructions which, when executed by one or more processors, cause the one or more processors to perform operations comprising:
receiving a first payment for an online order from a first user, the online order indicating an item purchased by the first user from an online merchant;
sending a message to one or more other users, the message indicating that the first user has initiated the online order from the online merchant and including an option to add a purchase to the online order;
receiving, from a second user of the one or more other users, a second payment and an indication of an item purchased by the second user from the online merchant;
aggregating the item purchased by the second user to the online order; and
fulfilling the online order including the item purchased by the first user and the item purchased by the second user.
